(19) United States
(12) Patent Application Publication
(10) Pub. No.: US 2003/0128714 A1
(43) Pub. Date: Jul. 10, 2003

(54) Multimedia communication system, multimedia communication method,and multimedia communication terminal

(76) Inventors: Takeshi Mio, Tokyo (JP); Susumu Oka, Tokyo (JP); Yukinari Matsuda, Tokyo (JP); Morio Yoshimoto, Tokyo (JP)

Correspondence Address: BIRCH STEWART KOLASCH & BIRCH, PO BOX 747, FALLS CHURCH, VA, 22040-0747, US

(21) Appl. No.: 10/220,740

(22) PCT Filed: Jan. 7, 2002
(86) PCT No.: PCT/JP02/00010

(51) Int. Cl. H04L 12/66; H04J 3/16

(52) U.S. Cl. 370/437; 370/352

(57) ABSTRACT

A communication terminal (1) connects, by way of a channel for multimedia communication set via a circuit switched network (4), with a communication service unit (2) so that the communication terminal (1) can send and receive multimedia information. The communication terminal (1) also connects, by way of a control channel set via a packet switched network (5), with an additional service unit 3 so that the communication terminal (1) can send and receive service control information associated with the multimedia information provided by the communication service unit (2). The additional service unit (3) receives the service control information transmitted from the communication terminal (1) by way of the packet switched network (5), transmits a service control signal to the communication service unit (2), and transmits another service control signal, such as the one specifying an operation mode or the one indicating service guidance information, to the communication terminal (1).

### FIELD OF THE INVENTION

The present invention relates to a multimedia communication system and a multimedia communication method including a communication service unit for providing a communication service using multimedia information for a multimedia communication terminal by way of a channel for multimedia communication, and an additional service unit for receiving and sending control information associated with the communication service provided by the communication service unit from and to the multimedia communication terminal by way of a control channel which is different from the channel for multimedia communication and which is handled as an independent call, and for performing a control process associated with the communication service, and the multimedia communication terminal.

### BACKGROUND OF THE INVENTION

FIG. 1 is an explanatory drawing showing the operation of a prior art multimedia communication terminal. In the figure, reference numeral 11 denotes a data communication terminal which is a prior art multimedia communication terminal, reference numeral 12 denotes a base station, reference numeral 13 denotes a packet switched network, reference numeral 14 denotes a circuit switched network, reference numeral 15 denotes an information supply server, reference numeral 16 denotes a packet gateway, reference numeral 17 denotes a multimedia stream server, and reference numeral 18 denotes a protocol conversion gateway.

For example, prior art multimedia communication terminals disclosed in Japanese patent application publications No. 2000-253180 and No. 1-125144 have a function of connecting with both a circuit switched network and a packet switched network, like the data communication terminal 11 shown in FIG. 1. Such a prior art multimedia communication terminal acquires multimedia information from the information supply server 15 by way of the base station 12, the circuit switched network 14, and the packet gateway 16, and acquires text-based information from the multimedia stream server 17 by way of the base station 12, the packet switched network 13, and the protocol conversion gateway 18. The prior art multimedia communication terminal thus selectively switches between communication networks (networks).

A problem with the prior art multimedia communication terminal that is so structured as to selectively switch between networks, which the prior art multimedia communication terminal uses, whenever necessary is however that the multimedia communication terminal can perform only a process of simply acquiring multimedia information and text-based information and cannot enjoy sophisticated applications that dynamically process both multimedia information and text-based information so that they are in conjunction with each other.

The present invention is proposed to solve the above-mentioned problems, and it is therefore an object of the present invention to provide a multimedia communication system and a multimedia communication method including a multimedia communication terminal that uses two communication channels at the same time, connects with an additional service unit by way of one of the two communication channels set via a packet switched network and to enable sending and receiving of a service control signal to enjoy an additional service while connecting with a communication service unit by way of the other channel set on a circuit switched network so as to receive a multimedia communication service, thereby relaxing restrictions on a band assigned to the multimedia information because of the sending and receiving of the service control information, and eliminating the need to perform a process of dividing the band into a plurality of parts, and the multimedia communication terminal.

It is another object of the present invention to provide a multimedia communication system and a multimedia communication method including a communication service unit that performs a process of producing multimedia information by selectively using all or part of multimedia information transmitted from a multimedia communication terminal and on the basis of a service control signal transmitted, by way of an additional service unit, from the multimedia communication terminal, thereby providing a communication service according to a user's demand or a sophisticated communication service for the multimedia communication terminal, and the multimedia communication terminal.

It is a further object of the present invention to provide a multimedia communication system and a multimedia communication method including a communication service unit that performs transmission control on various kinds of media information which constitute multimedia information to be sent to a multimedia communication terminal based on a service control signal transmitted, by way of an additional service unit, from the multimedia communication terminal, thereby making it possible to perform controlling such as transferring or stopping of the multimedia information, and the multimedia communication terminal.

It is still a further object of the present invention to provide a multimedia communication system and a multimedia communication method including a communication service unit that performs selection control on various kinds of media information which constitute multimedia information to be sent to a multimedia communication terminal based on a service control signal transmitted, by way of an additional service unit, from the multimedia communication terminal, thereby making it possible to select a predetermined piece of media information from the plurality of pieces of media information, and the multimedia communication terminal.

It is an additional object of the present invention to provide a multimedia communication system and a multimedia communication method including a plurality of multimedia communication terminals that simultaneously connect with a communication service unit by way of on a circuit switched network, and that simultaneously connect with an additional service unit by way of a packet switched network, so that each of the plurality of multimedia communication terminals can send and receive service control signals to enjoy an additional service, thereby enabling the communication service unit to select and use a multimedia signal or part of media signals from a certain multimedia communication terminal and to carry out generation, transmission control, and selection control of a new multimedia signal based on a service control signal from the additional service unit, and the multimedia communication terminal.

### DISCLOSURE OF THE INVENTION

In accordance with the present invention, a multimedia communication system includes a communication service unit for providing a communication service using multimedia information for a multimedia communication terminal by way of a channel for multimedia communication, and an additional service unit for receiving and sending control information associated with the communication service provided by the communication service unit from and to the multimedia communication terminal by way of a control channel which is different from the channel for multimedia communication and which is handled as an independent call, and for performing a control process associated with the communication service, wherein the additional service unit transmits a service control signal that is based on a result of performing the control process to the communication service unit and the communication service unit controls the communication service to be provided for the multimedia communication terminal based on the service control signal transmitted from the additional service unit.

As a result, the present invention offers an advantage of being able to relax restrictions on a band assigned to the multimedia information, which are imposed in association with the sending and receiving of the service control information, and to eliminate the need to perform a process of dividing the band into a plurality of parts.

In the multimedia communication system of the present invention, the communication service unit can perform the process of producing the multimedia information by selectively using all or part of multimedia information transmitted from the multimedia communication terminal and on the basis of the service control signal transmitted from the additional service unit.

As a result, the present invention offers an advantage of being able to provide a communication service accompanied with processing on the multimedia information according to a user's demand input via the multimedia communication terminal.

In accordance with the present invention, a multimedia communication method includes the steps of providing a communication service using multimedia information for a multimedia communication terminal by way of a channel for multimedia communication, receiving and sending control information associated with the communication service provided by the communication service unit from and to the multimedia communication terminal by way of a control channel which is different from the channel for multimedia communication and which is handled as an independent call, performing a control process associated with the communication service, and controlling the communication service to be provided for the multimedia communication terminal according to a service control signal that is based on a result of performing the control process.

As a result, the present invention offers an advantage of being able to relax restrictions on a band assigned to the multimedia information, which are imposed in association with the sending and receiving of the service control information, and to eliminate the need to perform a process of dividing the band into a plurality of parts.

In accordance with the present invention, when receiving a communication service using multimedia information from a communication service unit by way of a channel for multimedia communication, a multimedia communication terminal connects with an additional service unit by way of a control channel which is different from the channel for multimedia communication and which is handled as an independent call, receives and sends control information associated with the communication service provided by the communication service unit from and to the additional service unit so as to cause the additional service unit to perform a control process associated with the communication service, and receives the communication service controlled by the communication service unit according to a service control signal that is transmitted from the additional service unit and that is based on a result of performing the control process.

As a result, the multimedia communication terminal makes it possible to relax restrictions on a band assigned to the multimedia information, which are imposed in association with the sending and receiving of the service control information, and to eliminate the need to perform a process of dividing the band into a plurality of parts.

### BRIEF DESCRIPTION OF THE FIGURES

FIG. 1 is an explanatory drawing showing the operation of a prior art multimedia communication terminal;

FIG. 2 is a block diagram of a multimedia communication system according to embodiment 1 of the present invention;

FIG. 3 is a block diagram of a communication service unit in the multimedia communication system according to embodiment 1;

FIG. 4 is a block diagram of a multimedia communication system according to embodiment 2 of the present invention; and

FIG. 5 is a block diagram of a communication service unit in the multimedia communication system according to embodiment 2.

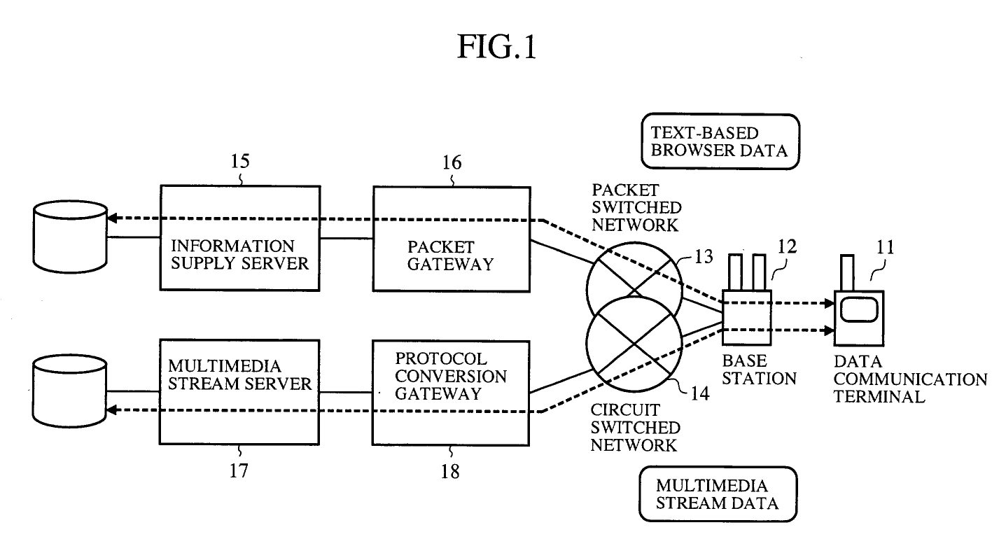

### PREFERRED EMBODIMENTS OF THE INVENTION

In order to explain the present invention in greater detail, the preferred embodiments will be described below with reference to the accompanying drawings.

Embodiment 1.

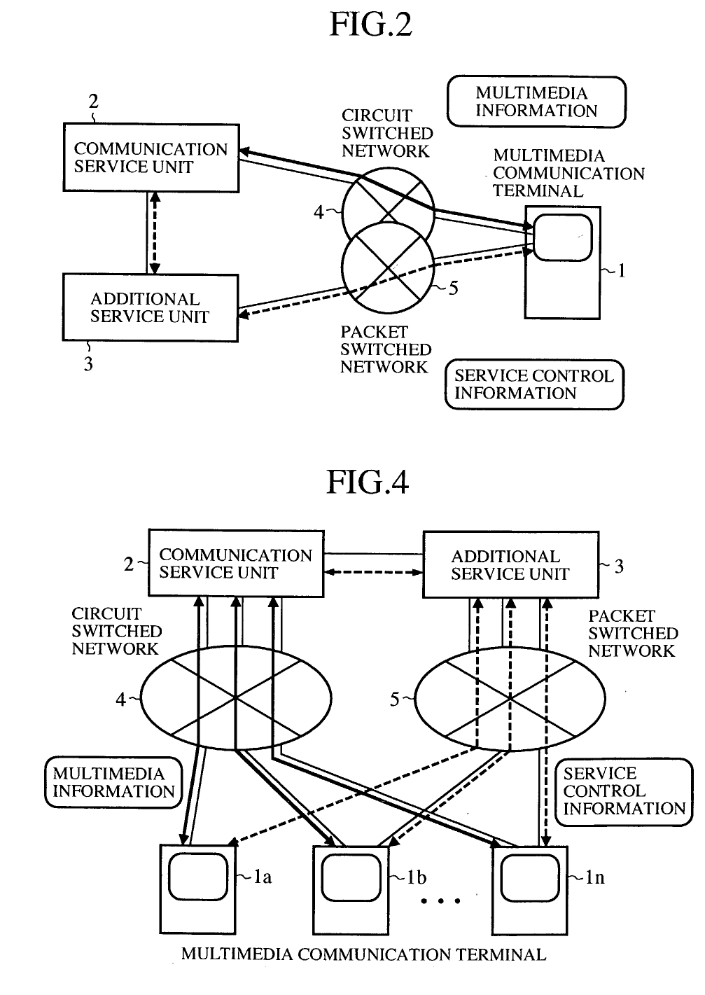

FIG. 2 is a block diagram of a multimedia communication system according to embodiment 1 of the present invention. In the figure, reference numeral 1 denotes a multimedia communication terminal, reference numeral 2 denotes a communication service unit, reference numeral 3 denotes an additional service unit, and reference numeral 4 denotes a circuit switched network, and reference numeral 5 denotes a packet switched network. In other words, FIG. 2 is a block diagram showing the multimedia communication system including the communication service unit 2 that provides a communication service using multimedia information for the multimedia communication terminal 1, and the additional service unit 3 that performs a process of receiving and sending control information associated with the communication service from and to the multimedia communication terminal 1.

In addition to the units mentioned above, the multimedia communication system needs a net terminating device that interfaces between each of the multimedia communication terminal 1, the communication service unit 2, and the additional service unit 3, and the circuit switched network 4 and the packet switched network 5. The explanation and illustration of the net terminating device will be omitted hereafter because the present invention does not relate directly to the net terminating device.

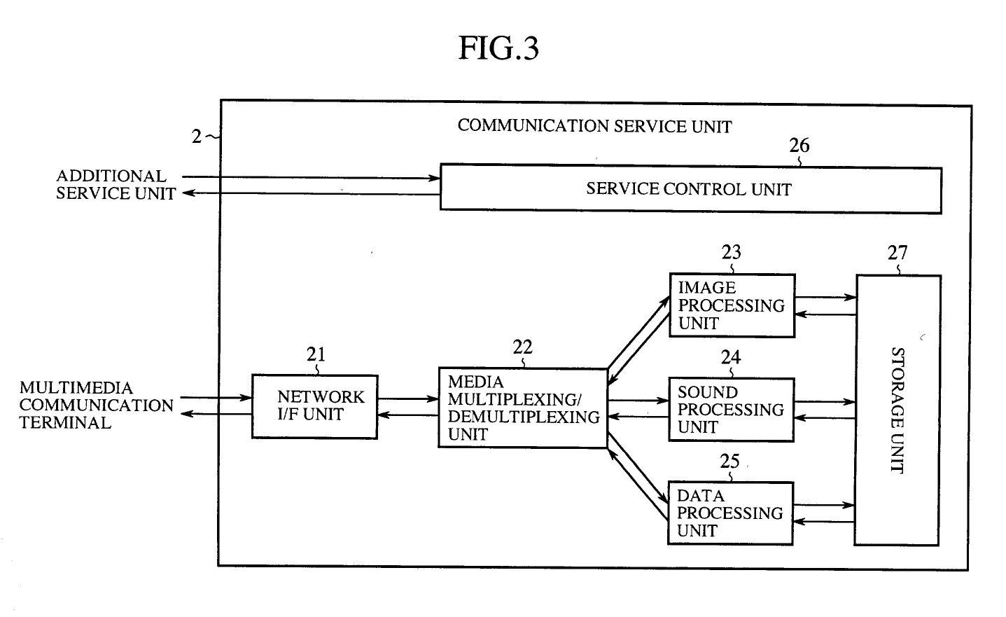

FIG. 3 is a block diagram of the communication service unit of embodiment 1. In the figure, reference numeral 21 denotes a network I/F unit, reference numeral 22 denotes a media multiplexing/demultiplexing unit, reference numeral 23 denotes an image processing unit, reference numeral 24 denotes a voice processing unit, reference numeral 25 denotes a data processing unit, reference numeral 26 denotes a service control unit, and reference numeral 27 denotes a storage unit.

Next, a description will be made as to the operation of the multimedia communication system.

First of all, the operation of the multimedia communication terminal 1 (referred to as the communication terminal 1) will be explained.

As shown in FIG. 2, in the case of transmission, the communication terminal 1 accepts either of an image signal, a voice signal, and arbitrary user data or a plurality of such media signals, sets a channel for multimedia communication on the circuit switched network 4 after performing corresponding encoding processing and media multiplexing processing on each medium, and outputs it to the communication service unit 2 by way of the channel for multimedia communication. On the other hand, in the case of reception, when the communication terminal 1 accepts multimedia information provided by the communication service unit 2 by way of the channel for multimedia communication set on the circuit switched network 4, the communication terminal 1 displays it on a display (not shown in the figure) or produces a sound output associated with the multimedia information so as to provide the multimedia information for the user after performing media demultiplexing and corresponding decoding on each medium.

At that time, the communication terminal 1 of this embodiment 1 connects, by way of the channel for multimedia communication (indicated by a solid line with arrows shown in FIG. 2) set via the circuit switched network 4, as mentioned above, with the communication service unit 2, and simultaneously sets a control channel (indicated by a broken line with arrows shown in FIG. 2), which is treated as an independent call and which differs from the channel for multimedia communication via the packet switched network 5 so that the communication terminal 1 can send and receive service control information associated with the multimedia information provided by the communication service unit 2 by connecting, by way of the control channel, with the additional service unit 3.

Next, the operation of the communication service unit 2 will be explained with reference to FIG. 3.

When the multimedia information is transmitted from the communication terminal 1 that is connected, by way of the circuit switched network 4, to the communication service unit 2, the communication service unit 2 receives the multimedia information from the communication terminal 1 through the I/F unit 21, demultiplexes the multimedia information input from the network I/F unit 21 line into pieces of media information such as an image signal, a voice signal, and data through the media multiplexing/demultiplexing unit 22, and outputs them to the image processing unit 23, the voice processing unit 24, and the data processing unit 25 which respectively process the pieces of media information, respectively.

Each of the image processing unit 23, the voice processing unit 24, and the data processing unit 25 performs corresponding processing on a corresponding piece of media information under control by the service control unit 26 based on a service control signal sent from the additional service unit 3, and stores the corresponding piece of media information in the storage unit 27 according to an instruction from the service control unit 26 if necessary, as described later.

At that time, since the communication terminal 1 of this embodiment 1 connects, by way of a channel for multimedia communication set via the circuit switched network 4, with the communication service unit 2, and simultaneously connects, by way of a control channel set via the packet switched network 5, with the additional service unit 3 so that the communication terminal 1 can send and receive service control information associated with the multimedia information provided by the communication service unit 2, the additional service unit 3 receives service control information transmitted from the communication terminal 1 by way of the control channel set via the packet switched network 5, transmits a service control signal to the communication service unit 2, and transmits another service control signal, such as the one specifying an operation mode or the one indicating service guidance information, to the communication terminal 1.

On the other hand, in the communication service unit 2, the service control unit 26 receives a service control signal transmitted from the additional service unit 3, selects a number of pieces of media information specified from various pieces of media information which have already been stored in the storage unit 27 according to the service control signal, and instructs the storage unit 27 to read out the specified number of pieces of media information. The storage unit 27 reads the specified number of pieces of media information according to the instruction from the service control unit 26, and outputs them to various media processing units, i.e., the image processing unit 23, the voice processing unit 24, and the data processing unit 25.

Each of the various types of media processing units 23 to 25 selects a corresponding one of various kinds of media signals input from the storage unit 27 according to an instruction from the service control unit 26, and output it to the media multiplexing/demultiplexing unit 22. The media multiplexing/demultiplexing unit 22 multiplexes the selected various kinds of media signals into multimedia information according to a predetermined syntax and outputs the multimedia information. Of course, at that time each of the various types of media processing units 23 to 25 does not simply output the corresponding one of various kinds of media signals input thereto from the storage unit 27 according to the instruction from the service control unit 26, but can process it, newly produce media information, or process the corresponding one of various kinds of media signals applied thereto from the media multiplexing/demultiplexing unit 22 so as to produce a kind of piece of media information to be output to the media multiplexing/demultiplexing unit 22.

Then, the communication terminal 1 can receive a service control signal indicating specification of the operation mode, service guidance information or the like from the additional service unit 3, can define a service reception environment or the like based on the service control signal, and can receive the multimedia information from the media multiplexing/demultiplexing unit 22 by way of the network I/F unit 21 of the communication service unit 2.

In this embodiment 1, the communication service unit 2 and the additional service unit 3 are disposed separately, as mentioned above. As an alternative, the communication service unit 2 and the additional service unit 3 can be integrated into an apparatus having their functions.

Furthermore, in this embodiment 1 the storage unit 27 is included in the communication service unit 2. As an alternative, the storage unit 27 can be disposed outside the communication service unit 2. The multimedia communication system can alternatively have a structure in which the storage unit 27 is omitted, so that no media information stored is used for producing multimedia information to be output to the communication terminal 1.

As mentioned above, in accordance with this embodiment 1, the multimedia communication terminal 1 can use two communication channels at the same time so as to send and receive service control signals to enjoy an additional service by connecting with the additional service unit 3 by way of one of the two communication channels set via the packet switched network 5 while receiving a multimedia communication service provided by connecting with the communication service unit 2 by way of the other channel, i.e., a channel for multimedia communication set via the circuit switched network 4. As a result, the present embodiment offers an advantage of being able to relax restrictions on a band assigned to the multimedia information, which are imposed in association with the sending and receiving of the service control information, and to eliminate the need to perform a process of dividing the band into a plurality of parts.

Furthermore, the communication service unit 2 can perform a process of producing the multimedia information by selectively using all or part of multimedia information transmitted from the multimedia communication terminal 1 and on the basis of a service control signal which has originated from the multimedia communication terminal 1 and which is transmitted from the additional service unit 3. As a result, the present embodiment offers another advantage of being able to provide a communication service accompanied with processing on the multimedia information according to a user's demand input via the multimedia communication terminal 1.

In addition, the communication service unit 2 performs transmission control on various kinds of media information which constitute multimedia information to be sent to the multimedia communication terminal 1 based on a service control signal transmitted, by way of the additional service unit 3, from the multimedia communication terminal 1. Therefore the present embodiment offers another advantage of being able to perform controlling such as transferring or stopping of the multimedia information.

Furthermore, the communication service unit 2 can perform selection control on various kinds of media information which constitute multimedia information to be sent to the multimedia communication terminal 1 based on a service control signal transmitted, by way of the additional service unit 3, from the multimedia communication terminal 1. Therefore the present embodiment offers another advantage of being able to select a predetermined piece of media information from the plurality of pieces of media information.

Embodiment 2.

FIG. 4 is a block diagram of a multimedia communication system according to embodiment 2 of the present invention. In the figure, reference numerals 1a to 1n denote a plurality of multimedia communication terminals that can carry out multi-point communications or the like, respectively, reference numeral 2 denotes a communication service unit, reference numeral 3 denotes an additional service unit, reference numeral 4 denotes a circuit switched network, and reference numeral 5 denotes a packet switched network. In other words, FIG. 4 is a block diagram showing the multimedia communication system including a communication service unit 2 that provides a communication service, such as multi-point communications using multimedia information, for a plurality of communication terminals 1a to 1n, respectively, and an additional service unit 3 that performs a process of receiving and sending communication service control information among the plurality of multimedia communication terminals 1a to 1n.

As in the case of above-mentioned embodiment 1, in addition to the units mentioned above, the multimedia communication system needs a net terminating device that interfaces between each of the plurality of multimedia communication terminals la to in, the communication service unit 2, and the additional service unit 3, and the circuit switched network 4 and the packet switched network 5. The explanation and illustration of the net terminating device will be omitted hereafter because the present invention does not relate directly to the net terminating device.

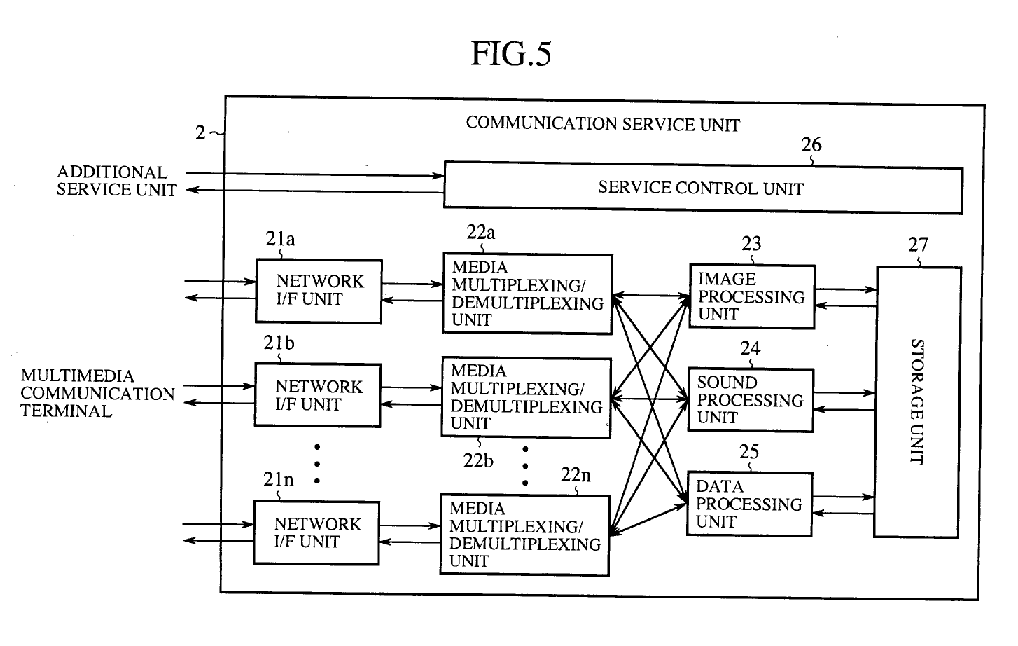

FIG. 5 is a block diagram of the communication service unit in the communication service system of embodiment 2. In the figure, reference numerals 21a to 21n denote network I/F units, respectively, reference numerals 22a to 22n denote media multiplexing/demultiplexing units, respectively, reference numeral 23 denotes an image processing unit, reference numeral 24 denotes a voice processing unit, reference numeral 25 denotes a data processing unit, reference numeral 26 denotes a service control unit, and reference numeral 27 denotes a storage unit.

Next, a description will be made as to the operation of the multimedia communication system of embodiment 2.

First of all, the operation of each of the plurality of multimedia communication terminals la to in (referred to as the plurality of communication terminals la to in) will be explained.

As shown in FIG. 4, in the case of transmission, each of the plurality of communication terminals 1a to 1n accepts either of an image signal, a voice signal, and arbitrary user data or a plurality of such media signals, sets a channel for multimedia communication on the circuit switched network 4 after performing corresponding encoding processing and media multiplexing processing on each medium, and outputs it to the communication service unit 2 by way of the channel for multimedia communication.

On the other hand, in the case of reception, when each of the plurality of communication terminals 1a to 1n accepts multimedia information provided by the communication service unit 2 by way of the channel for multimedia communication set 5 on the circuit switched network 4, each of the plurality of communication terminals 1a to 1n displays it on a display (not shown in the figure) or produces a voice output associated with the multimedia information so as to provide the multimedia information for users after performing media demultiplexing and corresponding decoding on each medium.

At that time, each of the plurality of communication terminals 1a to 1n of this embodiment 2 connects, by way of the channel for multimedia communication (indicated by a solid line with arrows shown in FIG. 4) set via the circuit switched network 4, as mentioned above, with the communication service unit 2, and simultaneously sets a control channel (indicated by a broken line with arrows shown in FIG. 4) set via the packet switched-network 5, which is different from the channel for multimedia communication and which is treated as an independent call, so that each of the plurality of communication terminals 1a to 1n can send and receive service control information associated with the multimedia information provided by the communication service unit 2 by connecting, by way of the control channel, with the additional service unit 3. There is a possibility that some of the plurality of communication terminals 1a to 1n only send service control information or some of them only receive service control information. However, each of the plurality of communication terminals 1a to 1n can basically send and receive service control information.

Next, the operation of the communication service unit 2 will be explained with reference to FIG. 5.

When the communication service unit 2 connects with each of the plurality of communication terminals 1a to 1n by setting a channel for multimedia communication by way of the circuit switched network 4 and multimedia information is transmitted from each of the plurality of communication terminals 1a to 1n, the communication service unit 2 receives the multimedia information from each of the plurality of communication terminals 1a to 1n through a corresponding one of the plurality of I/F units 21a to 21n, demultiplexes the multimedia information input from the corresponding one of the plurality of I/F units 21a to 21n into a plurality of pieces of media information through a corresponding one of the plurality of media multiplexing/demultiplexing units 22a to 22n, and outputs them to the image processing unit 23, the voice processing unit 24, and the data processing unit 25 which respectively process the plurality of pieces of media information, respectively.

Each of the image processing unit 23, the voice processing unit 24, and the data processing unit 25 performs corresponding processing on a corresponding piece of media information under control by the service control unit 26 based on the service control signal sent from the additional service unit 3, and stores the corresponding piece of media information in the storage unit 27 according to an instruction from the service control unit 26 if necessary, as described later.

In other words, since each of the plurality of communication terminals 1a to 1n of this embodiment 2 connects, by way of the channel for multimedia communication set via the circuit switched network 4, with the communication service unit 2, and simultaneously connects, by way of the control channel set via the packet switched network 5, with the additional service unit 3 so that each of the plurality of communication terminals 1a to 1n can send and receive service control information associated with the multimedia information provided by the communication service unit 2, the additional service unit 3 receives service control information transmitted from each of the plurality of communication terminals 1a to 1n by way of the control channel set via the packet switched network 5, transmits a service control signal to the communication service unit 2, and transmits another service control signal, such as the one specifying an operation mode or the one indicating service guidance information, to each of the plurality of communication terminals 1a to 1n.

Therefore, in the communication service unit 2, the service control unit 26 receives the service control signal transmitted from the additional service unit 3, and allows each of the image processing unit 23, the voice processing unit 24, and the data processing unit 25 to perform corresponding processing on corresponding media information based on the service control signal, and to store the media information in the storage unit 27 according to an instruction from the service control unit 26 if necessary.

Furthermore, the service control unit 26 selects a number of pieces of media information specified from various pieces of media information which have already been stored in the storage unit 27 according to the service control signal, and instructs the storage unit 27 to read out the specified number of pieces of media information. The storage unit 27 reads the specified number of pieces of media information according to the instruction from the service control unit 26, and outputs them to various media processing units, i.e., the image processing unit 23, the voice processing unit 24, and the data processing unit 25.

Each of the various types of media processing units 23 to 25 selects a corresponding one of various kinds of media signals applied thereto from the storage unit 27 according to an instruction from the service control unit 26, and outputs it to the plurality of media multiplexing/demultiplexing units 22a to 22n. Each of the media multiplexing/demultiplexing units 22a to 22n multiplexes the selected various kinds of media signals into multimedia information according to a predetermined syntax and outputs the multimedia information. Of course, at that time each of the various types of media processing units 23 to 25 does not simply output the corresponding one of various kinds of media signals input thereto from the storage unit 27 according to the instruction from the service control unit 26, but can newly produce a kind of piece of media information to be output to the plurality of media multiplexing/demultiplexing units 22a to 22n by processing the corresponding one of various kinds of media signals applied thereto from the plurality of media multiplexing/demultiplexing units 22a to 22n or switching the destinations of the various kinds of media signals among the plurality of media multiplexing/demultiplexing units 22a to 22n and processing them. Then, each of the plurality of communication terminals 1a to 1n can receive a service control signal indicating specification of the operation mode, service guidance information or the like from the additional service unit 3, can define a service reception environment or the like based on the service control signal, and can receive multimedia information from a corresponding one of the plurality of media multiplexing/demultiplexing units 22a to 22n by way of a corresponding one of the plurality of network I/F units 21a to 21n of the communication service unit 2.

In this embodiment 2, the communication service unit 2 and the additional service unit 3 are disposed separately, as shown in FIG. 4. As an alternative, the communication service unit 2 and the additional service unit 3 can be integrated into an apparatus having their functions.

Furthermore, in this embodiment 2 the storage unit 27 is included in the communication service unit 2. As an alternative, the storage unit 27 can be disposed outside the communication service unit 2. The multimedia communication system can alternatively have a structure in which the storage unit is omitted, so that no media information stored is used for producing multimedia information-to be output to each of the plurality of communication terminals 1a to 1n.

As mentioned above, in accordance with embodiment 2, each of the plurality of multimedia communication terminals 1a to 1n can use two communication channels at the same time so as to connect with the additional service unit 3 by way of one of the two communication channels set via the packet switched network 5 and to enable sending and receiving of a service control signal to enjoy an additional service while connecting with the communication service unit 2 by way of the other channel, i.e., a channel for multimedia communication set via the circuit switched network 4 so as to receive a multimedia communication service. As a result, the present embodiment offers an advantage of being able to relax restrictions on a band assigned to the multimedia information, which are imposed in association with the sending and receiving of the service control information, and to eliminate the need to perform a process of dividing the band into a plurality of parts.

Furthermore, the communication service unit 2 can perform a process of producing multimedia information by selectively using all or part of multimedia information transmitted from each of the plurality of multimedia communication terminals 1a to 1n and on the basis of a service control signal which has originated from each of the plurality of multimedia communication terminals 1a to 1n by way of the additional service unit 3. As a result, the multimedia communication system can provide a communication service accompanied with processing on the multimedia information.

In addition, since the communication service unit 2 can perform the process of producing multimedia information by selectively using all or part of a plurality of pieces of multimedia information transmitted from the plurality of multimedia communication terminals 1a to 1n and on the basis of service control signals which have originated from the plurality of multimedia communication terminals 1a to 1n by way of the additional service unit 3, the present embodiment offers an advantage of being able to provide a multi-point communication service to enable exchanges of all or part of the plurality of pieces of media information among the plurality of communication terminals 1a to 1n.

Furthermore, since the communication service unit 2 can perform the process of producing multimedia information by selectively using all or part of a plurality of pieces of multimedia information transmitted from the plurality of multimedia communication terminals 1a to 1n and on the basis of a service control signal which has originated from each of the plurality of multimedia communication terminals 1a to 1n by way of the additional service unit 3, the present embodiment offers an advantage of being able to allow each of the plurality of communication terminals 1a to 1n to mutually exert an influence upon the communication service provided by the communication service unit 2 according to the service control signal which has originated from each of the plurality of multimedia communication terminals 1a to 1n.

In addition, since the multimedia communication system can provide multi-point communication services among the plurality of communication terminals 1a to 1n by way of the communication service unit 2 and the additional service unit 3 so as to allow the plurality of communication terminals la to into interactively hand overcontrol information associated with the multimedia information multi-point communication services by way of the communication service unit 2 and the additional service unit 3, for example, the present embodiment offers another advantage of being able to provide, as a communication service, an application having a property of working in an interactive manner among the plurality of communication terminals 1a to 1n, such as a game application program to enable users on the plurality of communication terminals 1a to 1n to play a fighting game.

Furthermore, since the multimedia communication system can provide a multi-point meeting service among the plurality of communication terminals 1a to 1n by way of the communication service unit 2 and the additional communication service unit 3 so as to allow delivery of control signals between the communication service unit 2 and the additional communication service unit 3 and to allow the additional communication service unit 3 to control the communication service unit 2, the present embodiment offers another advantage of being able to carry out control of a meeting provided by the multi-point communication meeting service, such as screen selection, screen switching, and midway calling, without temporarily interrupting delivery of multi-point communication meeting information as multimedia information from the communication service unit 2.

In addition, the communication service unit 2 performs transmission control on various kinds of media information which constitute multimedia information to be sent to each of the plurality of multimedia communication terminals 1a to 1n based on a service control signal transmitted, by way of the additional service unit 3, from each of the plurality of multimedia communication terminals 1a to 1n. Therefore the present embodiment offers an advantage of being able to perform controlling such as transferring or stopping of the multimedia information for each of the plurality of multimedia communication terminals 1a to 1n.

Furthermore, the communication service unit 2 can perform selection control on various kinds of media information which constitute multimedia information to be sent to each of the plurality of multimedia communication terminals 1a to 1n based on a service control signal transmitted, by way of the additional service unit 3, from each of the plurality of multimedia communication terminals 1a to 1n. Therefore the present embodiment offers an advantage of being able to select a predetermined piece of media information from the plurality of pieces of media information for each of the plurality of multimedia communication terminals 1a to 1n.

Industrial Applicability

As mentioned above, the multimedia communication system, the multimedia communication method, and the multimedia communication terminal according to the present invention are suitable for implementation of communication services in which two communication channels are used at the same time, sending and receiving of multimedia information and communication service information are carried out without dividing a band for them into a plurality of parts, and users can manipulate the multimedia communication terminal so that the multimedia information can be processed according to their demands.

1. A multimedia communication system including a communication service unit for providing a communication service using multimedia information for a multimedia communication terminal by way of a channel for multimedia communication, and an additional service unit for receiving and sending control information associated with the communication service provided by said communication service unit from and to said multimedia communication terminal by way of a control channel which is different from the channel for multimedia communication and which is handled as an independent call, and for performing a control process associated with the communication service, characterized in that said additional service unit transmits a service control signal that is based on a result of performing the control process to said communication service unit and said communication service unit controls the communication service to be provided for said multimedia communication terminal based on the service control signal transmitted from said additional service unit.

2. The multimedia communication system according to claim 1, characterized in that said communication service unit performs a process of producing the multimedia information based on the service control signal transmitted from said additional service unit and transmits the multimedia information to said multimedia communication terminal by way of the channel for multimedia communication.

3. The multimedia communication system according to claim 2, characterized in that said communication service unit performs the process of producing the multimedia information by selectively using all or part of multimedia information transmitted from said multimedia communication terminal and on a basis of the service control signal transmitted from said additional service unit.

4. The multimedia communication system according to claim 1, characterized in that said additional service unit performs transmission control by transmitting a service control signal associated with the transmission control to said communication service unit, in, order to allow said communication service unit to transmit the multimedia information to said multimedia communication terminal.

5. The multimedia communication system according to claim 1, characterized in that said additional service unit performs selection control by transmitting a service control signal associated with a selection of multimedia information to be transmitted to said communication service unit, in order to allow said communication service unit to select multimedia information to be transmitted to said multimedia communication terminal.

6. The multimedia communication system according to claim 1, characterized in that said communication service unit controls a multi-point communication service to be provided for a plurality of multimedia communication terminals based on a service control signal transmitted from said additional service unit.

7. The multimedia communication system according to claim 1, characterized in that the multimedia information includes information on coded images.

8. The multimedia communication system according to claim 1, characterized in that the multimedia information includes information on coded voices.

9. The multimedia communication system according to claim 1, characterized in that the multimedia information includes information on user data.

10. The multimedia communication system according to claim 1, characterized in that the channel for multimedia communication is a communication channel provided by the circuit switched network, and the control channel which is different from the channel for multimedia communication and which is handled as an independent call is a communication channel provided by a packet switched network.

11. The multimedia communication system according to claim 1, characterized in that said communication service unit and said additional service unit are implemented via an identical piece of hardware.

12. A multimedia communication method of providing a communication service using multimedia information for a multimedia communication terminal by way of a channel for multimedia communication, receiving and sending control information associated with the communication service provided by said communication service unit from and to said multimedia communication terminal by way of a control channel which is different from the channel for multimedia communication and which is handled as an independent call, and performing a control process associated with the communication service, characterized in that said method comprises the step of controlling the communication service to be provided for said multimedia communication terminal according to a service control signal that is based on a result of performing the control process.

13. A multimedia communication terminal characterized in that, when receiving a communication service using multimedia information from a communication service unit by way of a channel for multimedia communication, said terminal connects with an additional service unit by way of a control channel which is different from the channel for multimedia communication and which is handled as an independent call, receives and sends control information associated with the communication service provided by said communication service unit from and to said additional service unit so as to cause said additional service unit to perform a control process associated with the communication service, and receives the communication service controlled by said communication service unit according to a service control signal that is transmitted from said additional service unit and that is based on a result of performing the control process.
